(19) United States
(12) Patent Application Publication
(10) Pub. No.: US 2026/0198413 A1
(43) Pub. Date: Jul. 16, 2026

(54) CONTROL SYSTEM FOR AN AGRICULTURAL HARVESTER CUTTER BAR ASSEMBLY

(71) Applicant: CNH Industrial America LLC, New Holland, PA (US)

(72) Inventor: Cory Douglas Hunt, Millersville, PA (US)

(21) Appl. No.: 19/129,977

(22) PCT Filed: Nov. 16, 2023
(86) PCT No.: PCT/US2023/079949

§ 371 Date: May 14, 2025

Related U.S. Application Data
(60) Provisional application No. 63/425,706, filed on Nov. 16, 2022.

(51) Int. Cl. A01D 34/00; A01D 34/28

(52) U.S. Cl. CPC A01D 34/006; A01D 34/286

(57) ABSTRACT

A control system for a cutter bar assembly of an agricultural harvester header includes a controller configured to perform a calibration process, which includes determining calibration angles of a frame of the agricultural harvester header about a lateral rotation axis relative to a mounting component as the frame rotates about the lateral rotation axis relative to the mounting component. The calibration process also includes determining sensor calibration distances between a sensor coupled to the frame of the agricultural harvester header and a ground surface, in which each sensor calibration distance is determined while the frame of the agricultural harvester header is oriented at a respective calibration angle. Furthermore, the calibration process includes determining offset distances based on the sensor calibration distances and determining calibration data based on the calibration angles and the offset distances.

### BACKGROUND

The present disclosure relates generally to a control system for an agricultural harvester cutter bar assembly.

A harvester may be used to harvest agricultural crops, such as barley, beans, beets, carrots, corn, cotton, flax, oats, potatoes, rye, soybeans, wheat, or other plant crops. Furthermore, a combine (e.g., combine harvester) is a type of harvester generally used to harvest certain crops that include grain (e.g., barley, corn, flax, oats, rye, wheat, etc.). During operation of a combine, the harvesting process may begin by removing a plant from a field, such as by using a header. The header may cut the agricultural crops and transport the cut crops to a processing system of the combine.

Certain headers include a cutter bar assembly configured to cut a portion of each crop (e.g., a stalk), thereby separating the cut crop from the soil. The cutter bar assembly may extend along a substantial portion of the width of the header at a forward end of the header. The header may also include one or more belts positioned behind the cutter bar assembly relative to the direction of travel of the harvester. The belt(s) are configured to transport the cut crops to an inlet of the processing system. Certain headers include a reel assembly configured to direct the crops cut by the cutter bar assembly toward the belt(s), thereby substantially reducing the possibility of the cut crops falling onto the surface of the field.

Certain headers include one or more sensors configured to monitor a height of the header above the surface of the field. For example, a non-contact sensor may be coupled to an arm of the reel assembly, and/or a non-contact sensor may be coupled to a support arm coupled to a frame of the header. In addition, one or more contact sensors may be coupled to the frame of the header. A controller may control a height of the cutter bar assembly above the surface of the field based on feedback from the sensor(s). For example, the controller may control actuator(s) to move the header frame vertically based on feedback from the sensor(s) to substantially maintain a height of the cutter bar assembly above the surface of the field, thereby cutting the crops at a substantially uniform height. In addition, actuator(s) may be configured to tilt the header frame about a lateral axis to control an angle of the cutter bar assembly relative to the surface of the field. Unfortunately, tilting the header frame about the lateral axis may vary the positional relationship between the sensor(s) and the cutter bar assembly, thereby reducing the accuracy of the cutter bar assembly height control process.

### BRIEF DESCRIPTION

In certain embodiments, a control system for a cutter bar assembly of an agricultural harvester header includes a controller having a memory and a processor. The controller is configured to perform a calibration process, which includes determining calibration angles of a frame of the agricultural harvester header about a lateral rotation axis relative to a mounting component as the frame rotates about the lateral rotation axis relative to the mounting component. The calibration process also includes determining sensor calibration distances between a sensor coupled to the frame of the agricultural harvester header and a ground surface, in which each sensor calibration distance is determined while the frame of the agricultural harvester header is oriented at a respective calibration angle. Furthermore, the calibration process includes determining offset distances based on the sensor calibration distances and determining calibration data based on the calibration angles and the offset distances. In addition, the controller is configured to determine an operational angle of the frame of the agricultural harvester header about the lateral rotation axis relative to the mounting component. The controller is also configured to determine a sensor operational distance between the sensor and the ground surface, and the controller is configured to control a height of the cutter bar assembly above the ground surface based on the operational angle, the sensor operational distance, and the calibration data.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of an agricultural harvester having a header;

FIG. 2 is a perspective view of an embodiment of a header that may be employed within the agricultural harvester of FIG. 1;

FIG. 3 is a block diagram of an embodiment of a control system that may be employed within the agricultural harvester of FIG. 1;

FIG. 4 is a flow diagram of an embodiment of a method for controlling a height of a cutter bar assembly of a header of an agricultural harvester;

FIG. 5 is a flow diagram of an embodiment of a method for controlling the height of the cutter bar assembly that may be employed within the method of FIG. 4; and

FIG. 6 is a flow diagram of an embodiment of a method for controlling the height of the cutter bar assembly that may be employed within the method of FIG. 4.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

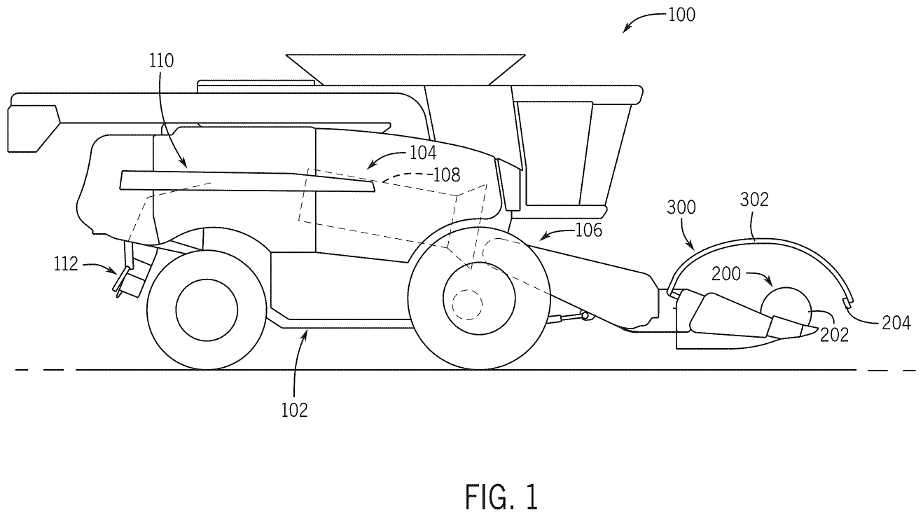

FIG. 1 is a side view of an embodiment of an agricultural harvester 100 having a header 200 (e.g., agricultural header, agricultural harvester header). The agricultural harvester 100 includes a chassis 102 configured to support the header 200 and an agricultural crop processing system 104. As described in greater detail below, the header 200 is configured to cut crops and to transport the cut crops toward an inlet 106 of the agricultural crop processing system 104 for further processing of the cut crops. The agricultural crop processing system 104 receives cut crops from the header 200 and separates desired crop material from crop residue. For example, the agricultural crop processing system 104 may include a thresher 108 having a cylindrical threshing rotor that transports the crops in a helical flow path through the harvester 100. In addition to transporting the crops, the thresher 108 may separate certain desired crop material (e.g., grain) from the crop residue, such as husks and pods, and the thresher 108 may enable the desired crop material to flow into a cleaning system located beneath the thresher 108. The cleaning system may remove debris from the desired crop material and transport the desired crop material to a storage compartment within the harvester 100. The crop residue may be transported from the thresher 108 to a crop residue handling system 110, which may remove the crop residue from the harvester 100 via a crop residue spreading system 112 positioned at the aft end of the harvester 100.

As discussed in detail below, the header 200 includes a cutter bar assembly configured to cut the crops within the field. In addition, the header 200 includes a reel assembly 202 configured to urge crops cut by the cutter bar assembly to belts that convey the cut crops toward the inlet 106 of the agricultural crop processing system 104. The reel assembly 202 includes a reel having multiple fingers extending from a central framework. The central framework is driven to rotate such that the fingers engage the cut crops and urge the cut crops toward the belts. While the header 200 includes the reel assembly 202 in the illustrated embodiment, in other embodiments, the reel assembly may be omitted.

In the illustrated embodiment, the header 200 includes one or more sensors 204 and a support system 300 configured to support the sensor(s) 204. The support system 300 includes one or more support arms 302, and each support arm 302 is coupled to one or more respective sensors 204. Each support arm 302 is configured to extend along a direction of travel of the header 200/agricultural harvester 100, and each support arm 302 is configured to extend over the reel of the reel assembly 202. Accordingly, each support arm 302 may position respective sensor(s) 204 at a location that enables the sensor(s) to monitor a height of the header 200 above a surface of the field.

As discussed in detail below, the header 200 includes a control system configured to control a height of the cutter bar assembly above the surface of the field based on feedback from the sensor(s) 204. In certain embodiments, the control system includes a controller configured to control the height of the cutter bar assembly during operation of the agricultural harvester. The controller is also configured to perform a calibration process before operation of the agricultural harvester. The calibration process includes determining multiple calibration angles of a frame of the header about a lateral rotation axis relative to a mounting component (e.g., a feeder house of the agricultural harvester, etc.) as the frame rotates about the lateral rotation axis relative to the mounting component. The calibration process also includes determining multiple sensor calibration distances between a sensor 204, which is coupled to the frame of the header 200, and the surface of the field (e.g., ground surface). Each sensor calibration distance is determined while the frame of the header is oriented at a respective calibration angle. In addition, the calibration process includes determining multiple offset distances based on the sensor calibration distances, and the calibration process includes determining calibration data based on the calibration angles and the offset distances. During operation of the agricultural harvester, the controller is configured to determine an operational angle of the header frame about the lateral rotation axis relative to the mounting component, and the controller is configured to determine a sensor operational distance between the sensor and the surface of the field (e.g., ground surface). The controller is also configured to control a height of the cutter bar assembly above the surface of the field (e.g., ground surface) based on the operational angle, the sensor operational distance, and the calibration data. Because the controller utilizes the calibration data to control the height of the cutter bar assembly, the accuracy of the cutter bar assembly height control process may be enhanced (e.g., as compared to controlling the height of the cutter bar assembly based on the sensor operational distance alone).

In certain embodiments, each offset distance corresponds to an angle dependent variation in a respective sensor calibration distance. In such embodiments, controlling the height of the cutter bar assembly may include determining a header height dependent sensor operational distance based on the calibration data, the operational angle, and the sensor operational distance, and controlling the height of the cutter bar assembly based on the header height dependent sensor operational distance. For example, in certain embodiments, the angle dependent variation/offset distance is equal to a difference between a respective sensor calibration distance and a baseline sensor calibration distance (e.g., the sensor calibration distance while the header frame is oriented at a baseline calibration angle). In addition, in certain embodiments, determining the header height dependent sensor operational distance includes using the calibration data to determine the offset distance corresponding to the operational angle and adding the offset distance to the sensor operational distance. The height of the cutter bar assembly may be controlled to substantially maintain the header height dependent sensor operational distance, thereby substantially maintaining the height of the cutter bar assembly above the ground surface.

Furthermore, in certain embodiments, each offset distance corresponds to a distance between the sensor and the cutter bar assembly. In such embodiments, controlling the height of the cutter bar assembly may include determining a determined height of the cutter bar assembly above the surface of the field (e.g., ground surface) based on the calibration data, the sensor operational distance, and the operational angle, and controlling the height of the cutter bar assembly based on the determined height of the cutter bar assembly above the surface of the field. In certain embodiments, the controller is configured to determine the offset distances based on the sensor calibration distances, the calibration angles, and at least one geometric property of the header (e.g., a distance between the cutter bar assembly and the lateral rotation axis). Alternatively, in certain embodiments, the controller is configured to determine each sensor calibration distance in response to receiving a signal indicative of contact between the cutter bar assembly and the ground surface.

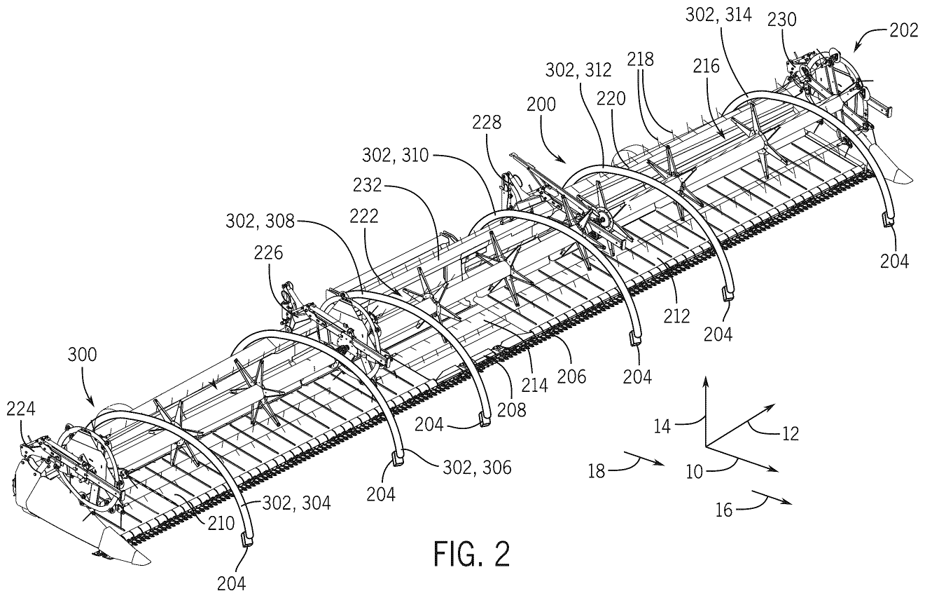

FIG. 2 is a perspective view of an embodiment of a header 200 that may be employed within the agricultural harvester of FIG. 1, in which the header 200 includes a support system 300 for sensors 204. In the illustrated embodiment, the header 200 includes a cutter bar assembly 206 configured to cut a portion of each crop (e.g., a stalk), thereby separating the crop from the soil. The cutter bar assembly 206 is positioned at a forward end of the header 200 relative to a longitudinal axis 10 of the header 200. As illustrated, the cutter bar assembly 206 extends along a substantial portion of the width of the header 200 (e.g., the extent of the header 200 along a lateral axis 12). The cutter bar assembly includes a blade support, a stationary guard assembly, and a moving blade assembly. The moving blade assembly is fixed to the blade support (e.g., above the blade support relative to a vertical axis 14 of the header 200), and the blade support/moving blade assembly is driven to oscillate relative to the stationary guard assembly. In the illustrated embodiment, the blade support/moving blade assembly is driven to oscillate by a driving mechanism 208 positioned at the lateral center of the header 200. However, in other embodiments, the blade support/moving blade assembly may be driven by another suitable mechanism (e.g., located at any suitable position on the header). As the harvester is driven through a field along a direction of travel 16 (e.g., which may be aligned with the longitudinal axis 10 of the header 200), the cutter bar assembly 206 engages crops within the field, and the moving blade assembly cuts the crops (e.g., the stalks of the crops) in response to engagement of the cutter bar assembly 206 with the crops.

In the illustrated embodiment, the header 200 includes a first lateral belt 210 on a first lateral side of the header 200 and a second lateral belt 212 on a second lateral side of the header 200, opposite the first lateral side. Each belt is driven to rotate by a suitable drive mechanism, such as an electric motor or a hydraulic motor. The first lateral belt 210 and the second lateral belt 212 are driven such that the top surface of each belt moves laterally inward. In addition, the header 200 includes a longitudinal belt 214 positioned between the first lateral belt 210 and the second lateral belt 212 along the lateral axis 12. The longitudinal belt 214 is driven to rotate by a suitable drive mechanism, such as an electric motor or a hydraulic motor. The longitudinal belt 214 is driven such that the top surface of the longitudinal belt 214 moves rearwardly along the longitudinal axis 10.

In the illustrated embodiment, the crops cut by the cutter bar assembly 206 are directed toward the belts by the reel assembly 202, thereby substantially reducing the possibility of the cut crops falling onto the surface of the field. The reel assembly 202 includes a reel 216 having multiple fingers 218 extending from a central framework 220. The central framework 220 is driven to rotate such that the fingers 218 move (e.g., in a circular pattern). The fingers 218 are configured to engage the cut crops and urge the cut crops toward the belts. The cut crops that contact the top surface of the lateral belts are driven laterally inwardly to the longitudinal belt due to the movement of the lateral belts. In addition, cut crops that contact the longitudinal belt 214 and the cut crops provided to the longitudinal belt by the lateral belts are driven rearwardly along the longitudinal axis 10 due to the movement of the longitudinal belt 214. Accordingly, the belts move the cut agricultural crops through an opening 222 in the header 200 to the inlet of the agricultural crop processing system.

In the illustrated embodiment, the reel 216 is supported by a first arm 224, a second arm 226, a third arm 228, and a fourth arm 230. However, in other embodiments, the reel may be supported by more or fewer arms (e.g., 1, 2, 3, 5, 6, or more). Furthermore, each arm is coupled (e.g., movably coupled) to a frame 232 of the header 200. The frame 232 also supports the cutter bar assembly 206 (e.g., via multiple arms extending between the frame 232 and the cutter bar assembly 206). In certain embodiments, an actuator is coupled to each arm and configured to drive the arm to rotate about the respective local lateral axis, thereby controlling a vertical position of the reel 216 relative to the frame 232 (e.g., to control engagement of the fingers of the reel with the cut agricultural crops).

In the illustrated embodiment, the header 200 includes multiple sensors 204. In certain embodiments, at least one sensor 204 may be configured to monitor a height of the header 200 above the surface of the field (e.g., relative to the vertical axis 14). The header height sensor(s) may include any suitable type(s) of sensor(s), such as light detection and ranging (LiDAR) sensor(s), radio detection and ranging (RADAR) sensor(s), ultrasonic sensor(s), other suitable type(s) of sensor(s), or a combination thereof. In the illustrated embodiment, the header 200 includes six sensors 204. However, in other embodiments, the header may include more or fewer sensors (e.g., 1, 2, 3, 4, 5, 7, 8, 9, 10, 11, 12, or more).

In the illustrated embodiment, the header 200 includes a support system 300 configured to support sensor(s) 204. As previously discussed, the support system 300 includes one or more support arms 302, and each support arm 302 is configured to support one or more respective sensors 204. In the illustrated embodiment, the support system 300 includes a first support arm 304 configured to support a single respective sensor 204, a second support arm 306 configured to support a single respective sensor 204, a third support arm 308 configured to support a single respective sensor 204, a fourth support arm 310 configured to support a single respective sensor 204, a fifth support arm 312 configured to support a single respective sensor 204, and a sixth support arm 314 configured to support a single respective sensor 204. Each support arm 302 is configured to extend along a forward longitudinal direction 18 relative to the direction of travel 16 of the agricultural header. In addition, each support arm 302 is configured to extend over the reel assembly 202 of the header 200.

While a single sensor 204 is coupled to each support arm 302 in the illustrated embodiment, in other embodiments, more or fewer sensors may be coupled to at least one support arm. For example, in certain embodiments, 0, 2, 3, 4, 5, 6, or more sensors may be coupled to at least one support arm. In addition, while the support system 300 includes six support arms 302 in the illustrated embodiment, in other embodiments, the support system may include more or fewer support arms (e.g., 1, 2, 3, 4, 5, 7, 8, or more). Furthermore, in certain embodiments, the support system may be omitted. In such embodiments, the sensor(s) may be coupled to other suitable portion(s) of the header.

As discussed in detail below, the header 200 includes a control system configured to control a height of the cutter bar assembly 206 above the surface of the field based on feedback from the sensor(s) 204. In certain embodiments, the control system includes a controller configured to control the height of the cutter bar assembly 206 during operation of the agricultural harvester. The controller is also configured to perform a calibration process before operation of the agricultural harvester. The calibration process includes determining multiple calibration angles of the frame 232 of the header 200 about a lateral rotation axis relative to a mounting component (e.g., a feeder house of the agricultural harvester, etc.) as the frame 232 rotates about the lateral rotation axis relative to the mounting component. The calibration process also includes determining multiple sensor calibration distances between a sensor 204, which is coupled to the frame 232 of the header 200 (e.g., via a support arm 302, etc.), and the surface of the field (e.g., ground surface). Each sensor calibration distance is determined while the frame 232 of the header 200 is oriented at a respective calibration angle. In addition, the calibration process includes determining multiple offset distances based on the sensor calibration distances, and the calibration process includes determining calibration data based on the calibration angles and the offset distances. During operation of the agricultural harvester, the controller is configured to determine an operational angle of the header frame 232 about the lateral rotation axis relative to the mounting component, and the controller is configured to determine a sensor operational distance between the sensor and the surface of the field (e.g., ground surface). The controller is also configured to control a height of the cutter bar assembly 206 above the surface of the field (e.g., ground surface) based on the operational angle, the sensor operational distance, and the calibration data. Because the controller utilizes the calibration data to control the height of the cutter bar assembly, the accuracy of the cutter bar assembly height control process may be enhanced (e.g., as compared to controlling the height of the cutter bar assembly based on the sensor operational distance alone).

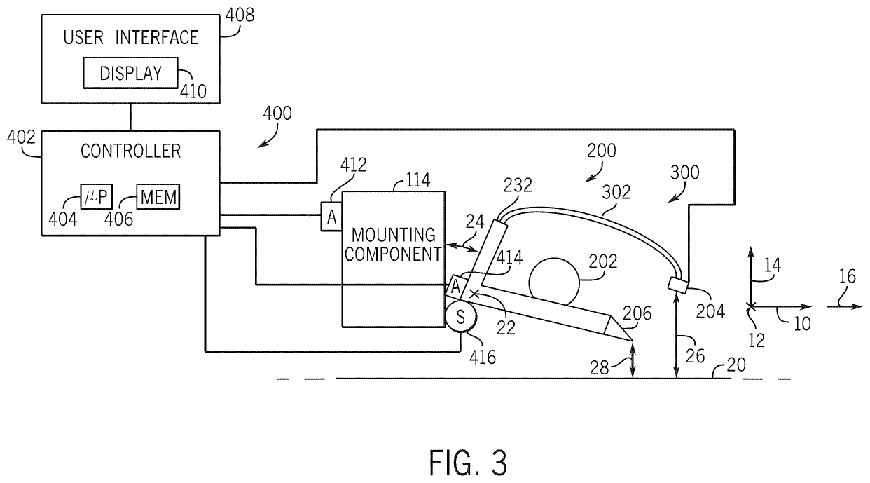

FIG. 3 is a block diagram of an embodiment of a control system 400 that may be employed within the agricultural harvester of FIG. 1. In the illustrated embodiment, the control system 400 includes a controller 402 configured to control a height of the cutter bar assembly 206 above the ground surface 20 (e.g., surface of the field). In certain embodiments, the controller 402 is an electronic controller having electrical circuitry configured to control a height control actuator to control the height of the cutter bar assembly 206 above the ground surface 20. In the illustrated embodiment, the controller 402 includes a processor, such as the illustrated microprocessor 404, and a memory device 406. The controller 402 may also include one or more storage devices and/or other suitable components. The processor 404 may be used to execute software, such as software for controlling the height of the cutter bar assembly 206, and so forth. Moreover, the processor 404 may include multiple microprocessors, one or more “general-purpose” microprocessors, one or more special-purpose microprocessors, and/or one or more application specific integrated circuits (ASICs), or some combination thereof. For example, the processor 404 may include one or more reduced instruction set (RISC) processors.

The memory device 406 may include a volatile memory, such as random access memory (RAM), and/or a nonvolatile memory, such as read-only memory (ROM). The memory device 406 may store a variety of information and may be used for various purposes. For example, the memory device 406 may store processor-executable instructions (e.g., firmware or software) for the processor 404 to execute, such as instructions for controlling the height of the cutter bar assembly 206 above the ground surface 20, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the height of the cutter bar assembly 206 above the ground surface 20, etc.), and any other suitable data.

Furthermore, in the illustrated embodiment, the control system 400 includes a user interface 408 communicatively coupled to the controller 402. The user interface 408 is configured to receive input from an operator and to provide information to the operator. The user interface 408 may include any suitable input device(s) for receiving input, such as a keyboard, a mouse, button(s), switch(es), knob(s), other suitable input device(s), or a combination thereof. In addition, the user interface 408 may include any suitable output device(s) for presenting information to the operator, such as speaker(s), indicator light(s), other suitable output device(s), or a combination thereof. In the illustrated embodiment, the user interface 408 includes a display 410 configured to present visual information to the operator. In certain embodiments, the display 410 may include a touchscreen interface configured to receive input from the operator.

In the illustrated embodiment, the control system 400 includes a height control actuator 412 communicatively coupled to the controller 402. The height control actuator 412 is configured to control a height of the frame 232 of the header 200 above the ground surface 20 (e.g., relative to the vertical axis 14). For example, in certain embodiments, the height control actuator 412 is disposed between a mounting component 114 (e.g., a feeder house, etc.) of the agricultural harvester and the chassis of the agricultural harvester, and the header frame 232 is pivotally coupled to the mounting component 114. Accordingly, the height control actuator 412 may move the mounting component 114 (e.g., relative to the vertical axis 14) to control the height of the frame 232 of the header 200 above the ground surface 20. While the height control actuator 412 is configured to move the mounting component 114 in the illustrated embodiment, in other embodiments, the height control actuator may be configured to directly move the header frame, or the height control actuator may be configured to move another suitable component coupled to the header frame. The height control actuator 412 may include any suitable type(s) of actuator(s), such as hydraulic cylinder(s), hydraulic motor(s), electric linear actuator(s), electric motor(s), pneumatic cylinder(s), pneumatic motor(s), other suitable type(s) of actuator(s), or a combination thereof.

Furthermore, in the illustrated embodiment, the control system 400 includes an angle control actuator 414 communicatively coupled to the controller 402. The angle control actuator 414 is configured to rotate the frame 232 of the header 200 about a lateral rotation axis 22 relative to the mounting component 114 to control an angle 24 of the header frame 232 about the lateral rotation axis 22 relative to the mounting component 114. In the illustrated embodiment, the header frame 232 is pivotally coupled to the mounting component 114 and configured to rotate relative to the mounting component 114 about the lateral rotation axis 22. In certain embodiments, the lateral rotation axis 22 is aligned with the lateral axis 12 of the header 200. The angle control actuator 414 may include any suitable type(s) of actuator(s), such as hydraulic cylinder(s), hydraulic motor(s), electric linear actuator(s), electric motor(s), pneumatic cylinder(s), pneumatic motor(s), other suitable type(s) of actuator(s), or a combination thereof.

In addition, in the illustrated embodiment, the control system 400 includes an angle sensor 416 configured to output a sensor signal indicative of the angle 24 of the header frame 232 about the lateral rotation axis 22 relative to the mounting component 114. In the illustrated embodiment, the angle sensor 416 is communicatively coupled to the controller 402 and configured to output the sensor signal to the controller 402. The angle sensor 416 may include any suitable type(s) of sensor(s), such as potentiometer(s), linear variable differential transformer(s), infrared sensor(s), ultrasonic sensor(s), other suitable type(s) of sensor(s), or a combination thereof.

As previously discussed, the header 200 includes one or more header height sensors 204 coupled to the frame 232 of the header 200 (e.g., via respective support arm(s) 302). Each header height sensor 204 is configured to output a sensor signal indicative of a distance 26 between the header height sensor 204 and the ground surface 20. As illustrated, the header height sensor(s) 204 are communicatively coupled to the controller 402 and configured to output the respective sensor signal(s) to the controller 402. The header height sensor(s) 204 may include any suitable type(s) of sensor(s), such as LiDAR sensor(s), RADAR sensor(s), ultrasonic sensor(s), other suitable type(s) of sensor(s), or a combination thereof. In certain embodiments, at least one header height sensor 204 is configured to monitor the distance 26 between the header height sensor 204 and the ground surface 20 along the vertical axis 14. Additionally or alternatively, at least one header height sensor 204 is configured to monitor the distance 26 between the header height sensor 204 and the ground surface 20 along a projection/monitoring path (e.g., light beam path, sound wave path, radio emission path, etc.). While the header height sensors disclosed above are non-contact sensors, in certain embodiments, at least one header height sensor may be a contact sensor coupled to the frame of the header (e.g., including a drag link positioned rearward of the cutter bar assembly relative to the direction of travel).

As discussed in detail below, the controller 402 is configured to control a height 28 of the cutter bar assembly 206 above the ground surface 20. The controller 402 is also configured to perform a calibration process before operation of the agricultural harvester (e.g., in response to input from the user interface 408). The calibration process includes determining multiple calibration angles (e.g., angles 24) of the frame 232 of the header 200 about the lateral rotation axis 22 relative to the mounting component 114 (e.g., feeder house, etc.) of the agricultural harvester as the frame 232 rotates about the lateral rotation axis 22 relative to the mounting component 114. For example, the controller 402 may control the angle control actuator 414 to drive the frame 232 to rotate (e.g., through an entire rotational range of motion of the frame 232), and the controller 402 may determine each calibration angle based on feedback from the angle sensor 416. The calibration process also includes determining multiple sensor calibration distances (e.g., distances 26) between the sensor 204, which is coupled to the frame 232 of the header 200, and the ground surface 20. Each sensor calibration distance is determined while the frame 232 of the header 200 is oriented at a respective calibration angle. For example, as the frame 232 rotates, the controller 402 may determine each sensor calibration distance based on feedback from the header height sensor(s) 204 while the frame 232 is oriented at a respective calibration angle, which may be determined based on feedback from the angle sensor 416. In addition, the calibration process includes determining multiple offset distances based on the sensor calibration distances, and the calibration process includes determining calibration data based on the calibration angles and the offset distances.

During operation of the agricultural harvester, the controller 402 is configured to determine an operational angle (e.g., angle 24) of the header frame 232 about the lateral rotation axis 22 relative to the mounting component 114. For example, the controller 402 may determine the operational angle based on feedback from the angle sensor 416. In addition, the controller 402 is configured to determine a sensor operational distance (e.g., distance 26) between the header height sensor(s) 204 and the ground surface 20. For example, the controller 402 may determine the sensor operational distance based on feedback from the header height sensor(s) 204. The controller 402 is also configured to control the height 28 of the cutter bar assembly 206 above the ground surface 20 based on the operational angle (e.g., angle 24), the sensor operational distance (e.g., distance 26), and the calibration data. For example, the controller 402 may control the height control actuator 412 to control the height of the cutter bar assembly 206 above the ground surface 20. Because the controller 402 utilizes the calibration data to control the height 28 of the cutter bar assembly 206, the accuracy of the cutter bar assembly height control process may be enhanced (e.g., as compared to controlling the height of the cutter bar assembly based on the sensor operational distance alone).

In certain embodiments, the controller 402 is configured to output information signal(s) to the user interface 408 indicative of the height of the cutter bar assembly above the ground surface, the operational angle of the frame about the lateral rotation axis relative to the mounting component, the operational distance between the header height sensor(s) and the ground surface, other suitable parameters, or a combination thereof. In response to receiving the information signal(s), the user interface 408 may present information indicative of the parameter(s) to the operator. For example, the user interface 408 may present the information on the display 410.

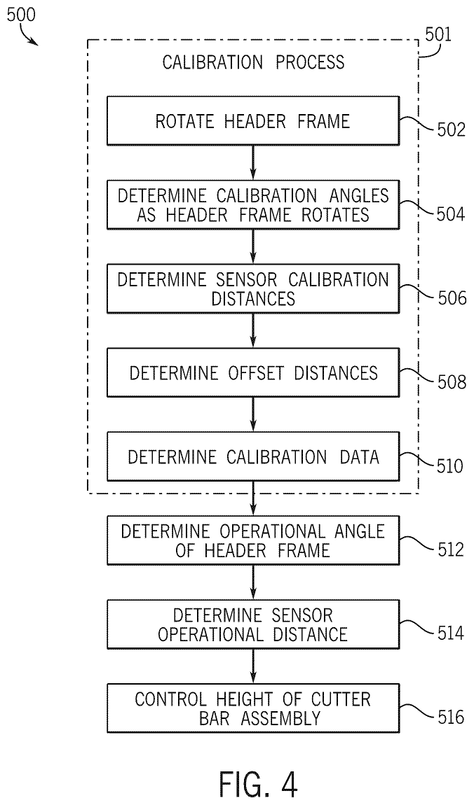

FIG. 4 is a flow diagram of an embodiment of a method 500 for controlling a height of a cutter bar assembly of a header of an agricultural harvester. The method 500 may be performed by the controller disclosed above with referenced to FIG. 3 or any other suitable controller(s). Furthermore, the steps of the method 500 may be performed in the order disclosed herein or in any other suitable order. For example, certain steps of the method may be performed concurrently. In addition, in certain embodiments, at least one of the steps of the method 500 may be omitted.

The method 500 includes performing a calibration process, as represented by block 501. The calibration process may be performed before operation of the agricultural harvester within the field. For example, the calibration process may be performed before each harvesting process, at the time of manufacturing the header, after modifying the header, after determining that the cutter bar assembly height control process is not operating effectively, or a combination thereof. In the illustrated embodiment, the calibration process includes controlling an actuator (e.g., the angle control actuator) to rotate the frame of the header about the lateral rotation axis relative to the mounting component, as represented by block 502. For example, in certain embodiments, the actuator may be controlled to rotate the header frame about the lateral rotation axis relative to the mounting component through an entire rotational range of motion of the header frame. However, in other embodiments, the actuator may be controlled to rotate the header frame about the lateral rotation axis relative to the mounting component through a portion of the rotational range of motion of the header frame. Furthermore, in certain embodiments, the step of controlling the actuator to rotate the header frame may be omitted. In such embodiments, the header frame may be rotated manually and/or via manual control of the actuator (e.g., the angle control actuator).

Furthermore, the calibration process includes determining multiple calibration angles of the frame of the agricultural harvester header about the lateral rotation axis relative to the mounting component as the frame rotates about the lateral rotation axis relative to the mounting component, as represented by block 504. For example, as previously discussed, each calibration angle may be determined based on feedback from the angle sensor. In addition, the calibration process includes determining multiple sensor calibration distances between the header height sensor(s) coupled to the frame of the header and the ground surface, as represented by block 506. Each sensor calibration distance is determined while the frame of the header is oriented at a respective calibration angle. For example, as the frame rotates, each sensor calibration distance may be determined based on feedback from the header height sensor(s) while the frame is oriented at a respective calibration angle, which may be determined based on feedback from the angle sensor. As previously discussed, the header height sensor(s) may include non-contact sensor(s) (e.g., LiDAR sensor(s), RADAR sensor(s), ultrasonic sensor(s), etc.) and/or contact sensor(s) (e.g., including drag link(s)).

In addition, as discussed in detail below, the calibration process includes determining multiple offset distances based on the sensor calibration distances, as represented by block 508. Furthermore, the calibration process includes determining calibration data based on the calibration angles and the offset distances, as represented by block 510. For example, in certain embodiments, the calibration data may include a table, a chart, or other suitable data structure having a list of calibration angles and a corresponding offset distance for each calibration angle. Furthermore, in certain embodiments, the calibration data may include a curve representative of offset distance as a function of calibration angle. The curve may be generated using any suitable curve fitting technique(s) (e.g., least squares, spline fit, etc.) based on the calibration angles and the corresponding offset distances. In addition, in certain embodiments, the calibration data may include an empirical formula determined based on the calibration angles and the corresponding offset distances.

During operation of the agricultural harvester (e.g., after the calibration process is complete), an operational angle of the header frame about the lateral rotation axis relative to the mounting component is determined, as represented by block 512. For example, as previously discussed, the operational angle may be determined based on feedback from the angle sensor. In addition, as represented by block 514, a sensor operational distance between the header height sensor(s) and the ground surface is determined (e.g., based on feedback from the header height sensor(s)). Next, as represented by block 516, the height of the cutter bar assembly above the ground surface is controlled based on the operational angle, the sensor operational distance, and the calibration data. For example, the height control actuator may be controlled to control the height of the cutter bar assembly above the ground surface. Because the calibration data is utilized to control the height of the cutter bar assembly, the accuracy of the cutter bar assembly height control process may be enhanced (e.g., as compared to controlling the height of the cutter bar assembly based on the sensor operational distance alone).

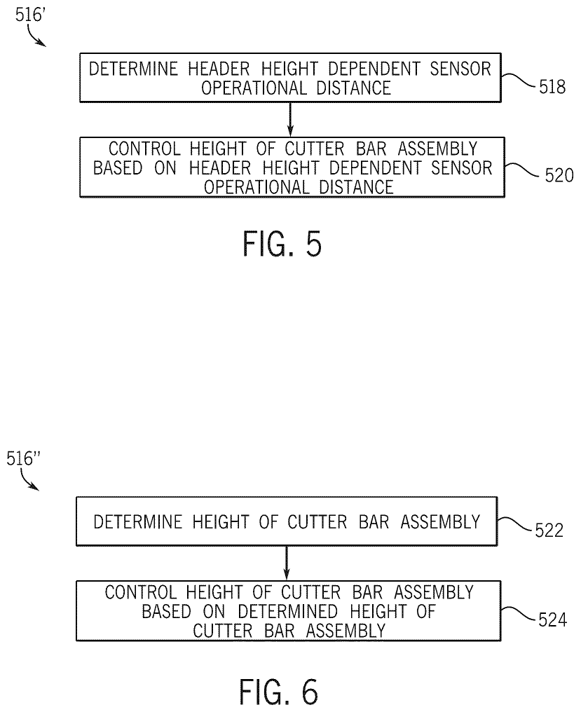

FIG. 5 is a flow diagram of an embodiment of a method 516′ for controlling the height of the cutter bar assembly that may be employed within the method of FIG. 4. The method 516′ may be performed by the controller disclosed above with referenced to FIG. 3 or any other suitable controller(s). Furthermore, the steps of the method 516′ may be performed in the order disclosed herein or in any other suitable order. For example, certain steps of the method may be performed concurrently. In addition, in certain embodiments, at least one of the steps of the method 516′ may be omitted.

In the illustrated embodiment, each offset distance corresponds to an angle dependent variation in a respective sensor calibration distance. In such embodiments, controlling the height of the cutter bar assembly includes determining a header height dependent sensor operational distance based on the calibration data, the operational angle, and the sensor operational distance, as represented by block 518. In addition, the height of the cutter bar assembly is controlled based on the header height dependent sensor operational distance, as represented by block 520. For example, in certain embodiments, the angle dependent variation/offset distance is equal to a difference between a respective sensor calibration distance and a baseline sensor calibration distance (e.g., the sensor calibration distance while the header frame is oriented at a baseline calibration angle). In certain embodiments, the baseline sensor calibration distance may correspond to the sensor calibration distance while the header frame is oriented at a minimum baseline calibration angle, the header frame is oriented at a maximum baseline calibration angle, or the header frame is oriented substantially parallel to the ground surface. The value of each angle dependent variation/offset distance may be positive or negative based on the value of the respective sensor calibration distance relative to the baseline sensor calibration distance (e.g., based on whether the respective sensor calibration distance is greater or less than the baseline sensor calibration distance). In addition, in certain embodiments, determining the header height dependent sensor operational distance includes using the calibration data to determine the offset distance corresponding to the operational angle and adding the offset distance (e.g., positive or negative offset distance) to the sensor operational distance. For example, the offset distance corresponding to the operational angle may be determined using the data structure disclosed above (e.g., via interpolation, etc.), using the curve disclosed above, or using the empirical formula disclosed above.

The height of the cutter bar assembly is controlled to substantially maintain the header height dependent sensor operational distance, thereby substantially maintaining the height of the cutter bar assembly above the ground surface. Because each offset distance corresponds to an angle dependent variation in a respective sensor calibration distance, the header height may be controlled to substantially maintain the height of the cutter bar assembly without using any geometric information about the header/header height sensor(s). Accordingly, a calibration process may be performed after any geometric rearrangement of the header/header height sensor(s), and the cutter bar assembly height may be effectively controlled without taking any measurements of the geometric rearrangement, thereby reducing the duration associated with the geometric rearrangement.

FIG. 6 is a flow diagram of an embodiment of a method 516″ for controlling the height of the cutter bar assembly that may be employed within the method of FIG. 4. The method 516″ may be performed by the controller disclosed above with referenced to FIG. 3 or any other suitable controller(s). Furthermore, the steps of the method 516″ may be performed in the order disclosed herein or in any other suitable order. For example, certain steps of the method may be performed concurrently. In addition, in certain embodiments, at least one of the steps of the method 516″ may be omitted.

In the illustrated embodiment, each offset distance corresponds to a distance between the header height sensor(s) and the cutter bar assembly. For example, in certain embodiments, the distance between the header height sensor(s) and the cutter bar assembly may correspond to the distance along the vertical axis (e.g., in embodiments in which the header height sensor(s) are configured to monitor the distance between the header height sensor(s) and the ground surface along the vertical axis). Furthermore, in certain embodiments, the distance between the header height sensor(s) and the cutter bar assembly may correspond to the distance along the projection/monitoring path of the header height sensor(s) (e.g., in embodiments in which the header height sensor(s) are configured to monitor the distance between the header height sensor(s) and the ground surface along the projection/monitoring path).

In embodiments in which each offset distance corresponds to the distance between the header height sensor(s) and the cutter bar assembly, controlling the height of the cutter bar assembly includes determining a determined height of the cutter bar assembly above the ground surface based on the calibration data, the sensor operational distance, and the operational angle, as represented by block 522. For example, the sensor operational distance may be determined based on feedback from the header height sensor(s). In addition, the calibration data may be used to determine the offset distance corresponding to the operational angle. For example, the offset distance corresponding to the operational angle may be determined using the data structure disclosed above (e.g., via interpolation, etc.), using the curve disclosed above, or using the empirical formula disclosed above. The offset distance may then be subtracted from the sensor operational distance to determine the determined height of the cutter bar assembly. Once the determined height of the cutter bar assembly above the ground surface is determined, the height of the cutter bar assembly is controlled based on the determined height of the cutter bar assembly, as represented by block 524. For example, during operation of the agricultural harvester, the height of the cutter bar assembly may be controlled to substantially maintain the determined height of the cutter bar assembly, and/or the height of the cutter bar assembly may be controlled such that the determined height of the cutter bar assembly is within a threshold range of a target height of the cutter bar assembly.

In certain embodiments, the offset distances are determined based on the sensor calibration distances, the calibration angles, and at least one geometric property of the header. For example, in certain embodiments (e.g., in embodiments in which the header height sensor(s) are configured to monitor the distance between the header height sensor(s) and the ground surface along the vertical axis), the at least one geometric property of the header may include a distance between the cutter bar assembly and the lateral rotation axis. In such embodiments, trigonometry may be used to determine the offset distance for each sensor calibration angle based on the sensor calibration distance, the calibration angle, and the distance between the cutter bar assembly and the lateral rotation axis. However, in other embodiments, other suitable geometric property/properties (e.g., alone or in combination with the distance between the cutter bar assembly and the lateral rotation axis) may be used in combination with the sensor calibration distances and the calibration angles to determine the offset distances. In certain embodiments, the cutter bar assembly may be placed in contact with the ground surface at the beginning of the calibration process to establish a baseline sensor calibration distance (e.g., sensor calibration distance while the height of the cutter bar assembly above the ground surface is zero). In such embodiments, the baseline sensor calibration distance may be used in combination with the sensor calibration distances, the calibration angles, and at least one geometric property of the header to determine the offset distances.

Alternatively, in certain embodiments, each sensor calibration distance is determined in response to receiving a signal indicative of contact between the cutter bar assembly and the ground surface. For example, the signal indicative of contact between the cutter bar assembly and the ground surface may be received from a contact sensor or a distance sensor coupled to the cutter bar assembly. Because each sensor calibration distance is determined while the cutter bar assembly is in contact with the ground surface, each offset distance is equal to a respective sensor calibration distance. Accordingly, the offset distances may be determined without the use of any geometric properties of the header. Accordingly, a calibration process may be performed after any geometric rearrangement of the header, and the cutter bar assembly height may be effectively controlled without taking any measurements of the geometric rearrangement, thereby reducing the duration associated with the geometric rearrangement.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A control system for a cutter bar assembly of an agricultural harvester header, comprising:
a controller comprising a memory and a processor, wherein the controller is configured to:
perform a calibration process comprising:
determining a plurality of calibration angles of a frame of the agricultural harvester header about a lateral rotation axis relative to a mounting component as the frame rotates about the lateral rotation axis relative to the mounting component;
determining a plurality of sensor calibration distances between a sensor coupled to the frame of the agricultural harvester header and a ground surface, wherein each sensor calibration distance of the plurality of sensor calibration distances is determined while the frame of the agricultural harvester header is oriented at a respective calibration angle of the plurality of calibration angles;
determining a plurality of offset distances based on the plurality of sensor calibration distances; and
determining calibration data based on the plurality of calibration angles and the plurality of offset distances;
determine an operational angle of the frame of the agricultural harvester header about the lateral rotation axis relative to the mounting component;
determine a sensor operational distance between the sensor and the ground surface; and
control a height of the cutter bar assembly above the ground surface based on the operational angle, the sensor operational distance, and the calibration data.

2. The control system of claim 1, wherein each offset distance of the plurality of offset distances corresponds to an angle dependent variation in a respective sensor calibration distance of the plurality of sensor calibration distances.

3. The control system of claim 2, wherein controlling the height of the cutter bar assembly comprises:
determining a header height dependent sensor operational distance based on the calibration data, the operational angle, and the sensor operational distance; and
controlling the height of the cutter bar assembly based on the header height dependent sensor operational distance.

4. The control system of claim 1, wherein each offset distance of the plurality of offset distances corresponds to a distance between the sensor and the cutter bar assembly.

5. The control system of claim 4, wherein controlling the height of the cutter bar assembly comprises:
determining a determined height of the cutter bar assembly above the ground surface based on the calibration data, the sensor operational distance, and the operational angle; and
controlling the height of the cutter bar assembly based on the determined height of the cutter bar assembly above the ground surface.

6. The control system of claim 4, wherein the controller is configured to determine the plurality of offset distances based on the plurality of sensor calibration distances, the plurality of calibration angles, and at least one geometric property of the agricultural harvester header.

7. The control system of claim 6, wherein the at least one geometric property comprises a distance between the cutter bar assembly and the lateral rotation axis.

8. The control system of claim 4, wherein the controller is configured to determine each sensor calibration distance of the plurality of sensor calibration distances in response to receiving a signal indicative of contact between the cutter bar assembly and the ground surface.

9. The control system of claim 1, wherein the controller is configured to control an actuator to rotate the frame of the agricultural harvester header about the lateral rotation axis relative to the mounting component during the calibration process.

10. The control system of claim 9, wherein the controller is configured to control the actuator to rotate the frame of the agricultural harvester header about the lateral rotation axis relative to the mounting component through an entire rotational range of motion of the frame.

11. A method for controlling a cutter bar assembly of an agricultural harvester header comprising:
performing, via a controller having a memory and a processor, a calibration process comprising:
determining, via the controller, a plurality of calibration angles of a frame of the agricultural harvester header about a lateral rotation axis relative to a mounting component as the frame rotates about the lateral rotation axis relative to the mounting component;
determining, via the controller, a plurality of sensor calibration distances between a sensor coupled to the frame of the agricultural harvester header and a ground surface, wherein each sensor calibration distance of the plurality of sensor calibration distances is determined while the frame of the agricultural harvester header is oriented at a respective calibration angle of the plurality of calibration angles;
determining, via the controller, a plurality of offset distances based on the plurality of sensor calibration distances; and
determining, via the controller, calibration data based on the plurality of calibration angles and the plurality of offset distances;
determining, via the controller, an operational angle of the frame of the agricultural harvester header about the lateral rotation axis relative to the mounting component;
determining, via the controller, a sensor operational distance between the sensor and the ground surface; and
controlling, via the controller, a height of the cutter bar assembly above the ground surface based on the operational angle, the sensor operational distance, and the calibration data.

12. The method of claim 11, wherein each offset distance of the plurality of offset distances corresponds to an angle dependent variation in a respective sensor calibration distance of the plurality of sensor calibration distances; and
wherein controlling the height of the cutter bar assembly comprises:
determining, via the controller, a header height dependent sensor operational distance based on the calibration data, the operational angle, and the sensor operational distance; and
controlling, via the controller, the height of the cutter bar assembly based on the header height dependent sensor operational distance.

13. The method of claim 11, wherein each offset distance of the plurality of offset distances corresponds to a distance between the sensor and the cutter bar assembly; and
wherein controlling the height of the cutter bar assembly comprises:
determining, via the controller, a determined height of the cutter bar assembly above the ground surface based on the calibration data, the sensor operational distance, and the operational angle; and
controlling, via the controller, the height of the cutter bar assembly based on the determined height of the cutter bar assembly above the ground surface.

14. The method of claim 13, wherein determining the plurality of offset distances is based on the plurality of sensor calibration distances, the plurality of calibration angles, and at least one geometric property of the agricultural harvester header.

15. The method of claim 13, wherein each sensor calibration distance of the plurality of sensor calibration distances is determined in response to receiving a signal indicative of contact between the cutter bar assembly and the ground surface.

16. At least one non-transitory computer-readable medium comprising processor-executable instructions that when executed by at least one processor cause the at least one processor to:
perform a calibration process comprising:
determining a plurality of calibration angles of a frame of the agricultural harvester header about a lateral rotation axis relative to a mounting component as the frame rotates about the lateral rotation axis relative to the mounting component;
determining a plurality of sensor calibration distances between a sensor coupled to the frame of the agricultural harvester header and a ground surface, wherein each sensor calibration distance of the plurality of sensor calibration distances is determined while the frame of the agricultural harvester header is oriented at a respective calibration angle of the plurality of calibration angles;
determining a plurality of offset distances based on the plurality of sensor calibration distances; and
determining calibration data based on the plurality of calibration angles and the plurality of offset distances;
determine an operational angle of the frame of the agricultural harvester header about the lateral rotation axis relative to the mounting component;
determine a sensor operational distance between the sensor and the ground surface; and
control a height of the cutter bar assembly above the ground surface based on the operational angle, the sensor operational distance, and the calibration data.

17. The at least one non-transitory computer-readable medium of claim 16, wherein each offset distance of the plurality of offset distances corresponds to an angle dependent variation in a respective sensor calibration distance of the plurality of sensor calibration distances; and
wherein controlling the height of the cutter bar assembly comprises:
determining a header height dependent sensor operational distance based on the calibration data, the operational angle, and the sensor operational distance; and
controlling the height of the cutter bar assembly based on the header height dependent sensor operational distance.

18. The at least one non-transitory computer-readable medium of claim 16, wherein each offset distance of the plurality of offset distances corresponds to a distance between the sensor and the cutter bar assembly; and
wherein controlling the height of the cutter bar assembly comprises:
determining a determined height of the cutter bar assembly above the ground surface based on the calibration data, the sensor operational distance, and the operational angle; and
controlling the height of the cutter bar assembly based on the determined height of the cutter bar assembly above the ground surface.

19. The at least one non-transitory computer-readable medium of claim 18, wherein the instructions when executed by the at least one processor cause the at least one processor to determine the plurality of offset distances based on the plurality of sensor calibration distances, the plurality of calibration angles, and at least one geometric property of the agricultural harvester header.

20. The at least one non-transitory computer-readable medium of claim 18, wherein the instructions when executed by the at least one processor cause the at least one processor to determine each sensor calibration distance of the plurality of sensor calibration distances in response to receiving a signal indicative of contact between the cutter bar assembly and the ground surface.
